(19) United States
(12) Patent Application Publication
(10) Pub. No.: US 2020/0079354 A1
(43) Pub. Date: Mar. 12, 2020

(54) VEHICLE POWER MANAGEMENT FAILURE

(71) Applicant: Ford Global Technologies, LLC, Dearborn, MI (US)

(72) Inventors: MAHRDAD DAMSAZ, Dexter, MI (US); HAMED BABAZADEHROKNI, Livonia, MI (US); KRITHIKA SWAMINATHAN, Dearborn, MI (US); MOSTAFA PARCHAMI, Dearborn, MI (US)

(73) Assignee: Ford Global Technologies, LLC, Dearborn, MI (US)

(21) Appl. No.: 16/127,705

(22) Filed: Sep. 11, 2018

(51) Int. Cl. B60W 20/50; B60W 30/09; B60L 3/04

(52) U.S. Cl. CPC B60W 20/50; B60L 11/1805; B60L 3/04; B60W 30/09

(57) ABSTRACT

A computer includes a processor and a memory storing processor-executable instructions. The processor is programmed to disconnect loads from a first bus of a vehicle in response to a power failure affecting the first bus and a second bus of the vehicle, and then navigate the vehicle to a stop. The loads are redundantly supplied by the first and second buses.

### BACKGROUND

Hybrid-electric, electric, and conventional (internal-combustion engine) vehicles typically include a power system for supplying power to various loads connected to buses. The power system typically includes a low-voltage battery, e.g., 12 or 48 volts, which can supply energy to the loads. In a hybrid-electric vehicle, the power system includes a DC/DC converter that supplies power to the loads unless the power demanded by the loads exceeds the capacity of the DC/DC converter, in which case the low-voltage battery supplies the loads. In the event of a power failure of the buses, the vehicle may not have sufficient energy remaining to power the loads during an emergency maneuver by the vehicle.

### BRIEF DESCRIPTION OF THE DRAWINGS

FIG. 1 is a block diagram of an example vehicle.

FIG. 2 is a top view of the vehicle of FIG. 1.

FIG. 3 is a block diagram of an example propulsion system of the vehicle of FIG. 1.

FIG. 4 is a circuit diagram of an example power-distribution system of the vehicle of FIG. 1.

FIG. 5 is a flow diagram of an example process for responding to a failure in the power-distribution system of FIG. 4.

FIG. 6 is a flow diagram of an example load-management strategy used for responding to the failure in the power-distribution system.

FIG. 7 is a flow diagram of another example load-management strategy used for responding to the failure in the power-distribution system.

### DETAILED DESCRIPTION

A power system performing as described herein can allow a vehicle to navigate for a longer period of time and/or to a safer location in the event of a power failure than it otherwise would have been able to. Navigating for a longer period of time may also allow for a smoother emergency stop. The power system can maintain a higher voltage during a power failure, which can improve the performance of some loads. The power system can thus increase the safety and reliability of the vehicle.

A computer includes a processor and a memory storing processor-executable instructions. The processor is programmed to disconnect loads from a first bus of a vehicle in response to a power failure affecting the first bus and a second bus of the vehicle, wherein the loads are redundantly supplied by the first and second buses, and then navigate the vehicle to a stop.

The processor may be further programmed to select a location for the vehicle to stop based on a calculated running time of the vehicle being greater than a time to navigate the vehicle to a stop at the location. The calculated running time of the vehicle may leave energy to accommodate at least one of transmitting a message or illuminating emergency lights after navigating the vehicle to the stop.

The processor may be further programmed to transmit a message to a remote server requesting a plurality of potential locations for the vehicle to stop, and select the location for the vehicle to stop from the potential locations returned by the remote server.

The processor may be further programmed to deactivate a plurality of sensors while navigating the vehicle to the stop, and the deactivated sensors may have a field of view at least one of redundant of a field of view of a still-active sensor or oriented in a direction that the vehicle will not travel while navigating to the stop.

The processor may be further programmed to estimate a time to navigate the vehicle to the stop, select a load-management strategy from a plurality of load-management strategies based on whether the load-management strategies can power the vehicle for the estimated time, and follow the selected load-management strategy. At least one of and fewer than all the load-management strategies may include deactivating a plurality of sensors while navigating the vehicle to the stop. The deactivated sensors may have a field of view at least one of redundant of a field of view of a still-active sensor or oriented in a direction that the vehicle will not travel while navigating to the stop.

The loads may be first loads, and the processor may be further programmed to instruct second loads to enter a low-power mode in response to the power failure.

A method includes disconnecting loads from a first bus of a vehicle in response to a power failure affecting the first bus and a second bus of the vehicle, wherein the loads are redundantly supplied by the first and second buses, and then navigating the vehicle to a stop.

The method may further include selecting a location for the vehicle to stop based on a calculated running time of the vehicle being greater than a time to navigate the vehicle to a stop at the location. The calculated running time of the vehicle may leave energy to accommodate at least one of transmitting a message or illuminating emergency lights after navigating the vehicle to the stop.

The method may further include transmitting a message to a remote server requesting a plurality of potential locations for the vehicle to stop, and selecting the location for the vehicle to stop from the potential locations returned by the remote server.

The method may further include deactivating a plurality of sensors while navigating the vehicle to the stop, and the deactivated sensors may have a field of view at least one of redundant of a field of view of a still-active sensor or oriented in a direction that the vehicle will not travel while navigating to the stop.

The method may further include estimating a time to navigate the vehicle to the stop, selecting a load-management strategy from a plurality of load-management strategies based on whether the load-management strategies can power the vehicle for the estimated time, and following the selected load-management strategy. At least one of and fewer than all the load-management strategies may include deactivating a plurality of sensors while navigating the vehicle to the stop. The deactivated sensors may have a field of view at least one of redundant of a field of view of a still-active sensor or oriented in a direction that the vehicle will not travel while navigating to the stop.

The loads may be first loads, and the method may further include instructing second loads to enter a low-power mode in response to the power failure.

With reference to the Figures, a computer 30 includes a processor and a memory storing processor-executable instructions. The processor is programmed to disconnect loads 32 from a first bus 34 of a vehicle 36 in response to a power failure affecting the first bus 34 and a second bus 38 of the vehicle 36, and then navigate the vehicle 36 to a stop. The loads 32 are redundantly supplied by the first and second buses 34, 38.

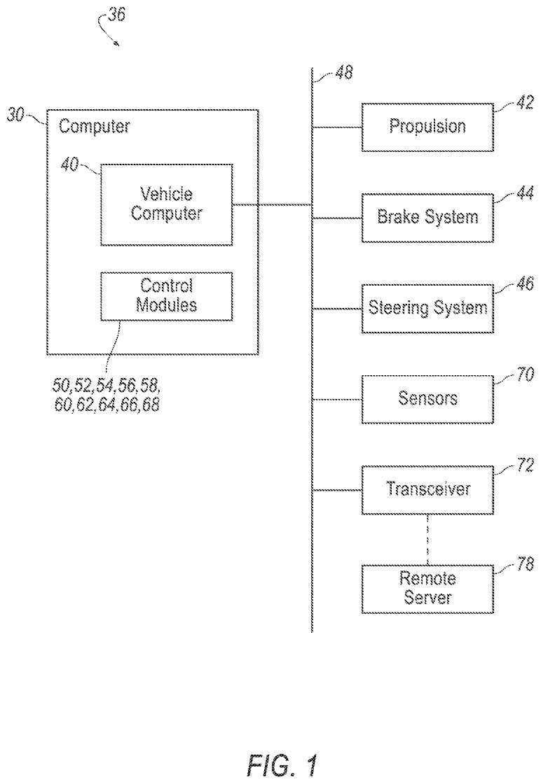

With reference to FIG. 1, the vehicle 36 may be any passenger or commercial automobile such as a car, a truck, a sport utility vehicle, a crossover, a van, a minivan, a taxi, a bus, etc.

The vehicle 36 may be an autonomous or semi-autonomous vehicle. A vehicle computer 40 can be programmed to operate the vehicle 36 independently of the intervention of a human driver, completely or to a lesser degree. The vehicle computer 40 may be programmed to operate a propulsion 42, brake system 44, steering system 46, and/or other vehicle systems. For the purposes of this disclosure, autonomous operation means the vehicle computer 40 controls the propulsion 42, brake system 44, and steering system 46 without input from a human operator; semi-autonomous operation means the vehicle computer 40 controls one or two of the propulsion 42, brake system 44, and steering system 46 and a human operator controls the remainder; and nonautonomous operation means a human operator controls the propulsion 42, brake system 44, and steering system 46.

The vehicle computer 40 is a microprocessor-based computer. The vehicle computer 40 includes a processor, memory, etc. The memory of the vehicle computer 40 includes memory for storing instructions executable by the processor as well as for electronically storing data and/or databases. The vehicle computer 40 is programmed to autonomously or semi-autonomously operate the vehicle 36.

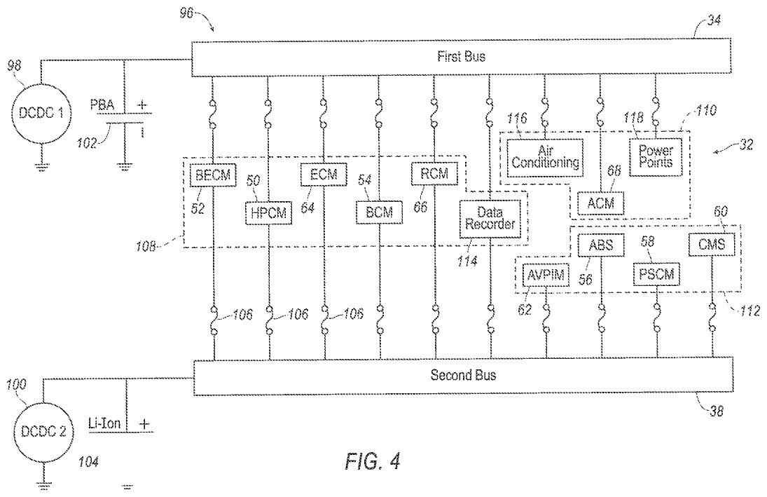

The computer 30 is one or more microprocessor-based computers. The computer 30 includes memory, at least one processor, etc. The memory of the computer 30 includes memory for storing instructions executable by the processor as well as for electronically storing data and/or databases. The computer 30 may be the same computer as the vehicle computer 40, or the computer 30 may be one or more separate computers in communication with the vehicle computer 40 via a communications network 48, or the computer 30 may encompass multiple computers including the vehicle computer 40. As a separate computer, the computer 30 may be or include, e.g., one or more electronic control units or modules (ECU or ECM) such as a hybrid-powertrain control module 50 and/or a battery-energy control module 52. Other ECMs may include a body control module 54, an antilock brake control module 56, a power-steering control module 58, a collision-mitigation-system control module 60, an autonomous-vehicle platform-interface control module 62, an engine control module 64, a restraint control module 66, and an accessory control module 68 (shown in FIG. 4).

The computer 30 may transmit and receive data through the communications network 48, which may be a controller area network (CAN) bus, Ethernet, WiFi, Local Interconnect Network (LIN), onboard diagnostics connector (OBD-II), and/or by any other wired or wireless communications network. The computer 30 may be communicatively coupled to the vehicle computer 40, the other ECMs 50, 52, 54, 56, 58, 60, 62, 64, 66, 68, the propulsion 42, the brake system 44, the steering system 46, sensors 70, a transceiver 72, and other components via the communications network 48.

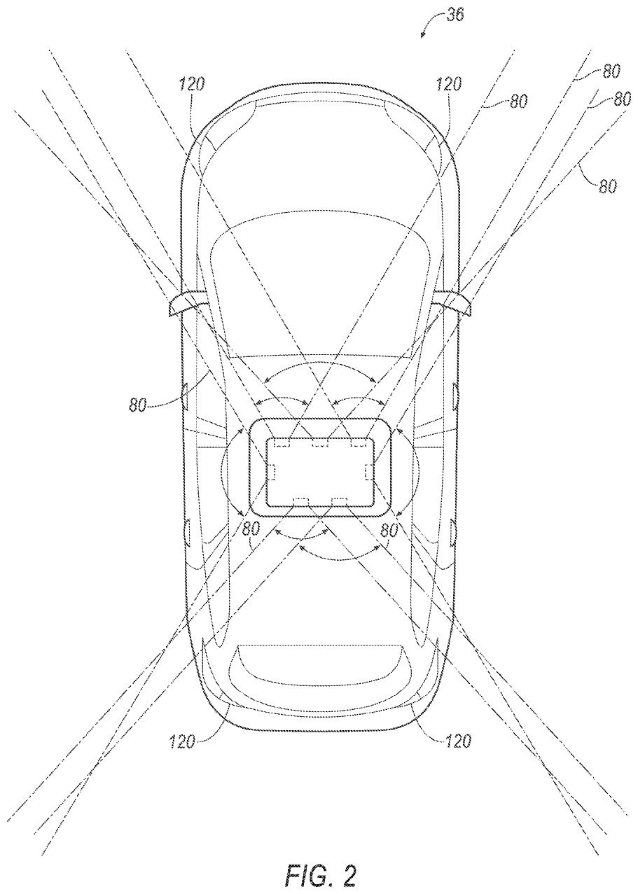

The propulsion 42 of the vehicle 36 generates energy and translates the energy into motion of the vehicle 36. In particular, the propulsion 42 may be hybrid propulsion. The propulsion 42 may include a powertrain 74 in any hybrid arrangement, e.g., a series-hybrid powertrain (as shown in FIG. 2), a parallel-hybrid powertrain, a power-split (series-parallel) hybrid powertrain, etc. The propulsion 42 is described in more detail below with respect to FIG. 2. The propulsion 42 can include an electronic control unit (ECU) or the like that is in communication with and receives input from the vehicle computer 40 and/or a human operator, e.g., the hybrid-powertrain control module 50. The human operator may control the propulsion 42 via, e.g., an accelerator pedal and/or a gear-shift lever.

The brake system 44 is typically a conventional vehicle braking subsystem and resists the motion of the vehicle 36 to thereby slow and/or stop the vehicle 36. The brake system 44 may include friction brakes such as disc brakes, drum brakes, band brakes, etc.; regenerative brakes; any other suitable type of brakes; or a combination. The brake system 44 can include an electronic control unit (ECU) or the like that is in communication with and receives input from the vehicle computer 40 and/or a human operator, e.g., the antilock brake control module 56. The human operator may control the brake system 44 via, e.g., a brake pedal.

The steering system 46 is typically a conventional vehicle steering subsystem and controls the turning of wheels 76. The steering system 46 may be a rack-and-pinion system with electric power-assisted steering, a steer-by-wire system, as both are known, or any other suitable system. The steering system 46 can include an electronic control unit (ECU) or the like that is in communication with and receives input from the vehicle computer 40 and/or a human operator, e.g., the power-steering control module 58. The human operator may control the steering system 46 via, e.g., a steering wheel.

The transceiver 72 may be adapted to transmit signals wirelessly through any suitable wireless communication protocol, such as Bluetooth®, WiFi, IEEE 802.11a/b/g, other RF (radio frequency) communications, etc. The transceiver 72 may be adapted to communicate with a remote server 78, that is, a server distinct and geographically distant from the vehicle 36 (distant in this context meaning physically separated, e.g., by a distance of meters, feet, miles, etc.). The remote server 78 may be located outside the vehicle 36. For example, the remote server 78 may be associated with other vehicles (e.g., V2V communications), infrastructure components (e.g., V2I communications via Dedicated Short-Range Communications (DSRC) or the like), emergency responders, mobile devices associated with the owner of the vehicle 36, etc. The transceiver 72 may be one device or may include a separate transmitter and receiver.

With reference to FIGS. 1 and 2, the sensors 70 may provide data about operation of the vehicle 36, for example, wheel speed, wheel orientation, and engine and transmission data (e.g., temperature, fuel consumption, etc.). The sensors 70 may detect the location and/or orientation of the vehicle 36. For example, the sensors 70 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 70 may detect the external world, e.g., objects and/or characteristics of surroundings of the vehicle 36, such as other vehicles, road lane markings, traffic lights and/or signs, pedestrians, etc. For example, the sensors 70 may include radar sensors, scanning laser range finders, light detection and ranging (LIDAR) devices, and image processing sensors such as cameras. Such sensors 70 may each have a field of view 80.

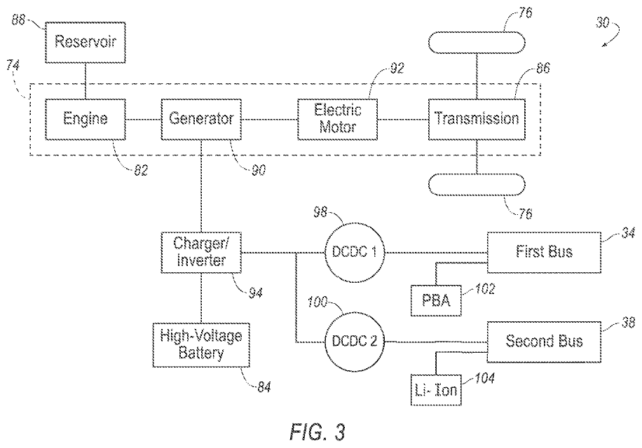

With reference to FIG. 3, the propulsion 42 includes the powertrain 74 that transmits power from an engine 82, from a high-voltage battery 84, or from both the engine 82 and the high-voltage battery 84, to a transmission 86 and ultimately to the wheels 76 of the vehicle 36. The engine 82 is an internal-combustion engine and may include cylinders that serve as combustion chambers that convert fuel from a reservoir 88 to rotational kinetic energy. A generator 90 may receive the rotational kinetic energy from the engine 82. The generator 90 converts the rotational kinetic energy into electricity, e.g., alternating current, and powers an electric motor 92. A charger/inverter 94 may convert the output of the generator 90, e.g., the alternating current, into high-voltage direct current to supply the high-voltage battery 84 and a power-distribution system 96. For the purposes of this disclosure, “high voltage” is defined as at least 60 volts direct current or at least 30 volts alternating current. For example, the high-voltage direct current may be on the order of 400 volts. The charger/inverter 94 controls how much power is supplied from the high-voltage battery 84 to the generator 90 of the powertrain 74. The electric motor 92 may convert the electricity from the generator 90 into rotational kinetic energy transmitted to the transmission 86. The transmission 86 transmits the kinetic energy via, e.g., a drive axle to the wheels 76, while applying a gear ratio allowing different tradeoffs between torque and rotational speed.

The high-voltage battery 84 produces a voltage of at least 60 volts direct current, e.g., on the order of 400 volts direct current. The high-voltage battery 84 may be any type suitable for providing high-voltage electricity for operating the vehicle 36, e.g., lithium-ion, lead-acid, etc. The high-voltage battery 84 is electrically coupled to the powertrain 74 via the charger/inverter 94.

With reference to FIGS. 3 and 4, the power-distribution system 96 may include a first DC/DC converter 98 and a second DC/DC converter 100. The DC/DC converters 98, 100 are electrically coupled to the powertrain 74 via the charger/inverter 94 (as shown in FIG. 2) and to respective first and second low-voltage batteries 102, 104. The DC/DC converters 98, 100 may receive high-voltage direct current from the charger/inverter 94 and/or the high-voltage battery 84 and convert the high-voltage direct current to low-voltage direct current. For the purposes of this disclosure, “low voltage” is defined as less than 60 volts direct current or less than 30 volts alternating current. For example, the low-voltage direct current may be 12 volts or 48 volts. Each DC/DC converter 98, 100 may exchange the low-voltage direct current with one of the low-voltage batteries 102, 104, and each DC/DC converter 98, 100 may supply the low-voltage direct current to one of the first and second buses 34, 38.

With reference to FIG. 4, the first and second buses 34, 38 divide electricity into subsidiary circuits, i.e., a plurality of loads 32. For the purposes of this disclosure, a “load” is an element of a circuit that draws power from the circuit. The first bus 34 electrically connects the first DC/DC converter 98 and the first low-voltage battery 102 to some of the loads 32, and the first bus 34 supplies those loads 32 with low-voltage direct current. The second bus 38 electrically connects the second DC/DC converter 100 and the second low-voltage battery 104 to some of the loads 32, and the second bus 38 supplies those loads 32 with low-voltage direct current. The loads 32 may each be connected to one or two of the first and second buses 34, 38 through one or more fuses 106.

The low-voltage batteries 102, 104 each produces a voltage less than 60 volts direct current, e.g., 12 or 48 volts direct current. The low-voltage batteries 102, 104 may be any type suitable for providing low-voltage electricity for power the loads 32, e.g., lithium-ion, lead-acid, etc. For example, the first low-voltage battery 102 electrically coupled to the first bus 34 is a lead-acid battery, and the second low-voltage battery 104 electrically coupled to the second bus 38 is a lithium-ion battery. The low-voltage batteries 102, 104 are electrically coupled to the powertrain 74 via the respective DC/DC converter 98, 100 and the charger/inverter 94.

The loads 32 include a first set 108 of the loads 32, a second set 110 of the loads 32, and a third set 112 of the loads 32. The first set 108 of the loads 32 includes loads 32 that are redundantly supplied by the first and second buses 34, 38. The first set 108 of loads 32 includes, e.g., the battery-energy control module 52, the hybrid-powertrain control module 50, the engine control module 64, the body control module 54, the restraint control module 66, and a data recorder 114. The second set 110 of loads 32 includes loads 32 that are supplied only by the first bus 34. The second set 110 of loads 32 includes, e.g., air conditioning 116, the accessory control module 68, and power points 118 (i.e., sockets in a passenger cabin for passengers to plug in personal devices). The third set 112 of loads 32 includes loads 32 that are supplied only by the second bus 38. The third set 112 of loads 32 may include the autonomous-vehicle platform-interface control module 62, the antilock brake control module 56, the power-steering control module 58, and the collision-mitigation-system control module 60.

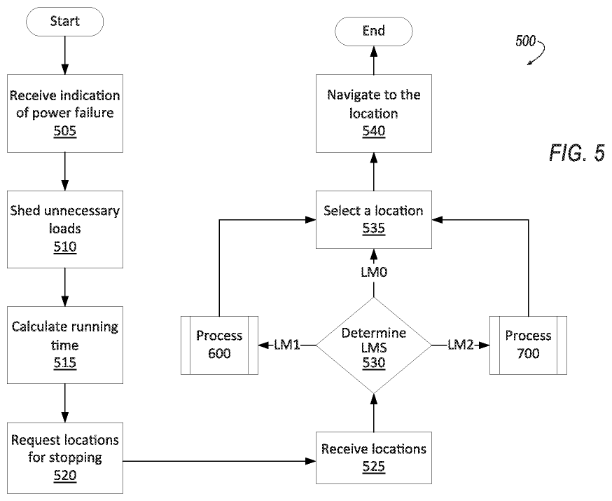

FIG. 5 is a process flow diagram illustrating an exemplary process 500 for responding to a failure in the power-distribution system 96. The memory of the computer 30 stores executable instructions for performing the steps of the process 500, which are executed by the processor of the computer 30. In general, after receiving an indication of a power failure, the computer 30 determines the running time of the vehicle 36, determines a load-management strategy, selects a location, and navigates the vehicle 36 to a stop at the location.

The process 500 begins in a block 505, in which the computer 30 receives an indication of a power failure affecting the first and second buses 34, 38. The computer 30 may receive data from voltage sensors or other electrical sensors connected to the power-distribution system 96. The data may indicate, e.g., a hard short or a soft short in either the first bus 34 or the second bus 38. For the purposes of this disclosure, a “hard short” is defined as a state of a circuit when the circuit is connected to ground, reducing voltage to substantially zero. For the purposes of this disclosure, a “soft short” is defined an impairment of a circuit other than a hard short, e.g., an open circuit; a malfunction of one of the ECMs 50, 52, 54, 56, 58, 60, 62, 64, 66, 68; excessive current flowing from one of the low-voltage batteries 102, 104; one or more of the ECMs 50, 52, 54, 56, 58, 60, 62, 64, 66, 68 drawing excessive power; a disabling of the high-voltage battery 84; overheating of one or more of the ECMs 50, 52, 54, 56, 58, 60, 62, 64, 66, 68; etc.

Next, in a block 510, the computer 30 sheds unnecessary loads 32 from the first and second buses 34, 38, i.e., electrically disconnects the unnecessary loads 32 from the first bus 34 or the second bus 38. One of the loads 32 is “unnecessary” if the load 32 does not impair the ability(ies) of the vehicle 36 to move, including steer, brake, accelerate, decelerate, and/or maintain a speed. For example, the air conditioning 116, the accessory control module 68, and the power points may be unnecessary loads 32.

Next, in a block 515, the computer 30 calculates a running time of the vehicle 36, i.e., a time that the vehicle 36 can continue to operate before a system necessary for driving loses power. For example, the computer 30 may divide the remaining energy in the low-voltage batteries 102, 104 by the rate at which the power-distribution system 96 is using power. So that the computer 30 leave energy to accommodate one or both of transmitting a message via the transceiver 72 or illuminating emergency lights 120, the remaining energy in the low-voltage batteries 102, 104 may be reduced by the amount to transmit a message and/or illuminate the emergency lights 120 while calculating the running time. For example, the following equation may be used:

$${t}_{running} = \frac{{w}_{batt} - {w}_{emerg}}{P}$$

in which t_{running} is the running time, w_{batt} is the energy remaining in the low-voltage batteries 102, 104, w_{emerg} is the energy to transmit a message and/or illuminate the emergency lights 120, and P is the rate of electricity used by the power-distribution system 96.

Next, in a block 520, the computer 30 requests potential locations for the vehicle 36 to stop. For example, the computer 30 may transmit a message to the remote server 78 requesting a plurality of potential locations for the vehicle 36 to stop via the transceiver 72. The remote server 78 may be an infrastructure component, and the message may be a V2I message. The message may include a current location of the vehicle 36, the running time t_{running}, a fault code corresponding to the cause of the power failure, etc. For another example, the computer 30 may search for potential locations using its own navigation software. The potential locations may be a nearest parking lot, a nearest road with a sufficiently wide shoulder to accommodate the vehicle 36, a rightmost lane in a road along which the vehicle 36 is currently driving, etc.

Next, in a block 525, the computer 30 may receive the potential locations. For example, the computer 30 may receive the plurality of potential locations from the remote server 78 via the transceiver 72. For another example, the computer 30 may receive the results of its own search.

Next, in a decision block 530, the computer 30 selects a load-management strategy from a plurality of load-management strategies. For example, the load-management strategies may include LM0, LM1, and LM2. The load-management strategy LM0 is to continue operating the vehicle 36 with the currently running loads 32, i.e., shedding the loads 32 that were shed in the block 510 and continuing to power the remaining loads 32. The load-management strategy LM1 is described below as a process 600, and the load-management strategy LM2 is described below as a process 700. The computer 30 calculates the running times of the vehicle 36 under the respective strategies. The running time for LM0 is the same running time t_{running}. Calculating the running times for LM1 and LM2 is the same as performed in the block 515, but only considering the loads 32 that will still be powered in LM1 or LM2, i.e., the power P only includes the power consumed by the loads 32 still powered in LM1 or LM2. The computer 30 may compare the running times to estimated times to navigate the vehicle 36 to a stop at the potential locations. The computer 30 selects the load-management strategy based on whether the load-management strategies can power the vehicle 36 for the estimated times to navigate the vehicle 36 to a stop at the potential locations. For example, the computer 30 may select the load-management strategy that can power the vehicle 36 to the safest of the potential locations, and if more than one load-management strategy can do so, select the least aggressive load-management strategy that can do so. The safety of the potential locations may be ranked according to how separated the potential locations are from traffic, e.g., a parking lot is safer than a road shoulder, and a road shoulder is safer than a traffic lane. The aggressiveness of the load-management strategies may be ranked according to how much power consumption is reduced; LM2 is more aggressive than LM1, and LM1 is more aggressive than LM0. If the computer 30 selects LM0, the process 500 proceeds to a block 535. If the computer 30 selects LM1, the computer 30 performs the process 600, and then the process 500 resumes at the block 535. If the computer 30 selects LM2, the computer 30 performs the process 700, and then the process 500 resumes at the block 535.

After the load-management strategy is implemented, in the block 535, the computer 30 selects a location for the vehicle 36 to stop from among the potential locations. The computer 30 has the calculated running times stored from the block 515, from a block 625 in the process 600, or from a block 715 in the process 700. The computer 30 selects from among the potential locations for which the calculated running time of the vehicle 36 is greater than the time to navigate to the location, i.e., from among the potential locations to which the vehicle 36 can operate under the selected load-management strategy and then transmit a message and/or illuminate emergency lights 120. The computer 30 selects the location that is safest from among the satisfactory potential locations.

Next, in a block 540, the computer 30 navigates the vehicle 36 to a stop at the selected location. The computer 30 may use known autonomous-operation algorithms to navigate the vehicle 36 along a route to the location, or the computer 30 may instruct the vehicle computer 40 to do so. After the block 540, the process 500 ends.

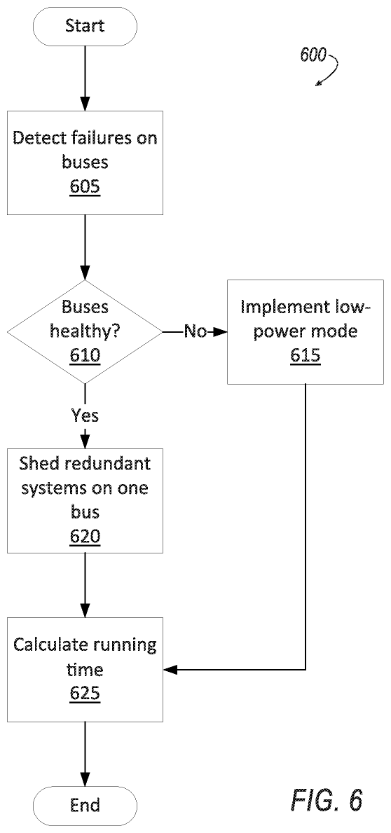

FIG. 6 is a process flow diagram illustrating an exemplary process 600 for implementing the load-management strategy LM1. The memory of the computer 30 stores executable instructions for performing the steps of the process 600. In general, if the first and second buses 34, 38 are both operational, the computer 30 disconnects redundant loads 32 from one of the buses 34, 38; if one of the first and second buses 34, 38 has failed, the computer 30 instructs some of the loads 32 to enter a low-power mode.

The process 600 begins in a block 605, which may occur after the decision block 530 as described above. In the block 605, the computer 30 detects the failures on the first and second buses 34, 38. The computer 30 may receive data from voltage sensors or other electrical sensors connected to the power-distribution system 96.

Next, in a decision block 610, the computer 30 determines whether both the first bus 34 and the second bus 38 are healthy, i.e., have not shorted out completely and are supplying at least some power to the loads 32. The computer 30 uses the data received in the block 605. If both the first bus 34 and the second bus 38 are healthy, the process 600 proceeds to a block 620.

If one of the buses 34, 38 is shorted out, next, in a block 615, the computer 30 instructs the second set 110 of loads 32 or the third set 112 of loads 32 (whichever is connected to the healthy of the first and second buses 34, 38) to enter a low-power mode. For the purposes of this disclosure, a “low-power mode” for a load 32 is defined as a mode of operation for the load 32 that is only used during emergencies and that draws less power than a typical mode of operation for the load 32.

If both the first bus 34 and the second bus 38 are healthy, after the decision block 610, in the block 620, the computer 30 disconnects the first set 108 of loads 32 from either the first bus 34 or the second bus 38, i.e., disconnects the loads 32 that are redundantly supplied by the first and second buses 34, 38 from either the first bus 34 or the second bus 38.

After the block 615 or the block 620, in a block 625, the computer 30 calculates the running time of the vehicle 36. For example, the computer 30 may divide the remaining energy in the low-voltage batteries 102, 104 by the rate at which the power-distribution system 96 is using power under the load-management strategy LM1, e.g., with this equation:

$${t}_{running} = \frac{{w}_{batt} - {w}_{emerg}}{{P}_{LM 1}}$$

in which t_{running} is the running time, w_{batt} is the energy remaining in the low-voltage batteries 102, 104, w_{emerg} is the energy to transmit a message and/or illuminate the emergency lights 120, and P_{LM1} is the rate of electricity used by the power-distribution system 96 under the load-management strategy LM1. After the block 625, the process 600 ends.

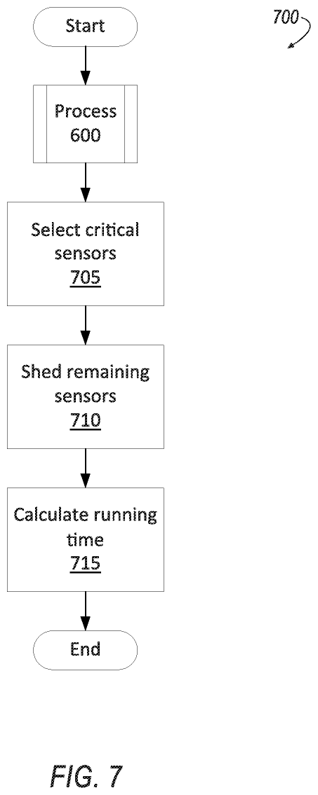

FIG. 7 is a process flow diagram illustrating an exemplary process 700 for implementing the load-management strategy LM2. The memory of the computer 30 stores executable instructions for performing the steps of the process 700. In general, the computer 30 performs the load-management strategy LM1 and then deactivates the sensors 70 that are redundant or unnecessary for navigating to the location.

The process 700 begins by performing the process 600, which may occur after the decision block 530 as described above. After the process 600 is completed, the process 700 proceeds to a block 705.

In the block 705, the computer 30 selects the sensors 70 that are critical and noncritical from among the sensors 70. The critical sensors 70 are necessary for navigating to a stop at the location, and the noncritical sensors 70 are unnecessary for this purpose. For example, the noncritical sensors 70 may have fields of view 80 that are redundant of the field of view 80 of a critical sensor 70; for example, the middle forward-facing sensor 70 shown in FIG. 2 has a field of view 80 redundant of the left and right forward-facing sensors 70 and of left- and right-facing sensors 70. For another example, the noncritical sensors 70 may have fields of view 80 oriented in a direction that the vehicle 36 will not travel while navigating to the stop; for example, the left- and rear-facing sensors 70 shown in FIG. 2 are noncritical if the vehicle 36 will navigate to the location using only forward travel and right turns. The directions that the vehicle 36 will travel is determined using the potential locations received in the block 525. For example, if the potential locations are a rightmost lane of the current road and driveway on the right side of the road a block ahead of the vehicle 36, then the vehicle 36 will only need to travel forward and turn right.

Next, in a block 710, the computer 30 deactivates the sensors 70 selected as noncritical in the block 705.

Next, in a block 715, the computer 30 calculates the running time of the vehicle 36. For example, the computer 30 may divide the remaining energy in the low-voltage batteries 102, 104 by the rate at which the power-distribution system 96 is using power under the load-management strategy LM2, e.g., with this equation:

$${t}_{running} = \frac{{w}_{batt} - {w}_{emerg}}{{P}_{LM 2}}$$

in which t_{running} is the running time, w_{batt} is the energy remaining in the low-voltage batteries 102, 104, w_{emerg} is the energy to transmit a message and/or illuminate the emergency lights 120, and P_{LM2} is the rate of electricity used by the power-distribution system 96 under the load-management strategy LM1. After the block 715, the process 700 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer comprising a processor and a memory storing processor-executable instructions, the processor programmed to:
disconnect loads from a first bus of a vehicle in response to a power failure affecting the first bus and a second bus of the vehicle, wherein the loads are redundantly supplied by the first and second buses; and
then navigate the vehicle to a stop.

2. The computer of claim 1, wherein the processor is further programmed to select a location for the vehicle to stop based on a calculated running time of the vehicle being greater than a time to navigate the vehicle to a stop at the location.

3. The computer of claim 2, wherein the calculated running time of the vehicle leaves energy to accommodate at least one of transmitting a message or illuminating emergency lights after navigating the vehicle to the stop.

4. The computer of claim 2, wherein the processor is further programmed to transmit a message to a remote server requesting a plurality of potential locations for the vehicle to stop, and select the location for the vehicle to stop from the potential locations returned by the remote server.

5. The computer of claim 1, wherein the processor is further programmed to deactivate a plurality of sensors while navigating the vehicle to the stop, and the deactivated sensors have a field of view at least one of redundant of a field of view of a still-active sensor or oriented in a direction that the vehicle will not travel while navigating to the stop.

6. The computer of claim 1, wherein the processor is further programmed to estimate a time to navigate the vehicle to the stop, select a load-management strategy from a plurality of load-management strategies based on whether the load-management strategies can power the vehicle for the estimated time, and follow the selected load-management strategy.

7. The computer of claim 6, wherein at least one of and fewer than all the load-management strategies include deactivating a plurality of sensors while navigating the vehicle to the stop.

8. The computer of claim 7, wherein the deactivated sensors have a field of view at least one of redundant of a field of view of a still-active sensor or oriented in a direction that the vehicle will not travel while navigating to the stop.

9. The computer of claim 1, wherein the loads are first loads, and the processor is further programmed to instruct second loads to enter a low-power mode in response to the power failure.

10. A method comprising:
disconnecting loads from a first bus of a vehicle in response to a power failure affecting the first bus and a second bus of the vehicle, wherein the loads are redundantly supplied by the first and second buses; and
then navigating the vehicle to a stop.

11. The method of claim 10, further comprising selecting a location for the vehicle to stop based on a calculated running time of the vehicle being greater than a time to navigate the vehicle to a stop at the location.

12. The method of claim 11, wherein the calculated running time of the vehicle leaves energy to accommodate at least one of transmitting a message or illuminating emergency lights after navigating the vehicle to the stop.

13. The method of claim 11, further comprising transmitting a message to a remote server requesting a plurality of potential locations for the vehicle to stop, and selecting the location for the vehicle to stop from the potential locations returned by the remote server.

14. The method of claim 10, further comprising deactivating a plurality of sensors while navigating the vehicle to the stop, wherein the deactivated sensors have a field of view at least one of redundant of a field of view of a still-active sensor or oriented in a direction that the vehicle will not travel while navigating to the stop.

15. The method of claim 10, further comprising estimating a time to navigate the vehicle to the stop, selecting a load-management strategy from a plurality of load-management strategies based on whether the load-management strategies can power the vehicle for the estimated time, and following the selected load-management strategy.

16. The method of claim 15, wherein at least one of and fewer than all the load-management strategies include deactivating a plurality of sensors while navigating the vehicle to the stop.

17. The method of claim 16, wherein the deactivated sensors have a field of view at least one of redundant of a field of view of a still-active sensor or oriented in a direction that the vehicle will not travel while navigating to the stop.

18. The method of claim 10, wherein the loads are first loads, the method further comprising instructing second loads to enter a low-power mode in response to the power failure.
